(19) United States
(12) Patent Application Publication
(10) Pub. No.: US 2017/0368900 A1
(43) Pub. Date: Dec. 28, 2017

(54) HYDRAULIC SUSPENSION SYSTEM FOR A BED TRUCK AND METHOD FOR CONTROL THEREOF

(71) Applicant: OPTION INDUSTRIES INC., Calgary (CA)

(72) Inventors: Dustin KOS, Calgary (CA); Tony WONG, Calgary (CA); Marlin BELANGER, Calgary (CA)

(21) Appl. No.: 15/631,879

(22) Filed: Jun. 23, 2017

Related U.S. Application Data
(60) Provisional application No. 62/354,517, filed on Jun. 24, 2016.

(51) Int. Cl. B60G 17/017; B60G 13/08; B60G 17/005

(52) U.S. Cl. CPC B60G 17/017; B60G 17/005; B60G 13/08; B60G 2600/042; B60G 2500/30; B60G 2401/17; B60G 2400/60; B60G 2400/252; B60G 2300/0262; B60G 2202/414; B60G 2202/24; B60G 2600/18; B60G 2600/20; B60G 2400/5182

(57) ABSTRACT

A bed truck having multiple axles has a hydraulic suspension including multiple hydraulic cylinders for each axle, a ride height sensor associated with each hydraulic cylinder, a high pressure hydraulic circuit connecting each of the cylinders and accumulators to a hydraulic pressure source, a low pressure hydraulic circuit connecting each of the cylinders to a fluid tank, and a plurality of valves operable to isolate operation of any one hydraulic cylinder from some or all of the other hydraulic cylinders. A control system is operable to control each of the hydraulic cylinders, either independently of all the other hydraulic cylinders, or in concert with one or more other hydraulic cylinders, such control including locking any one or more of the hydraulic cylinders at a minimum ride height position.

### FIELD OF THE INVENTION

The present invention relates to a hydraulic suspension system for a bed truck, and method for controlling the hydraulic suspension system of a bed truck.

### BACKGROUND OF THE INVENTION

Bed trucks are used in the heavy transport and oil and gas service industry to load, transport and unload heavy loads, particularly in cases where cargo is too heavy for ordinary tractor/trailers to carry. Some bed trucks use a winch mounted at the front end of the bed to pull loads onto the bed over the rear of the bed.

Bed trucks must be able to operate safely both on public highways and off-road in challenging terrain. Bed trucks must also comply with government regulations which relate to safe operation on public highways.

The suspension systems of these vehicles are important for operator comfort, productivity, and safety. The suspension system may be adjustable depending upon the weight of the load applied to the equipment. A very heavy load may compress the suspension, forcing the vehicle body downward with respect to the axles, which can adversely affect the maneuverability of the vehicle. On the other hand, if the suspension is configured for relatively heavy loads, the vehicle may have an undesirably tall ride height under lighter loads.

As a result, many vehicles have automatic load leveling systems which employ one or more hydraulic cylinders between the axle and the frame of the vehicle to ensure that the frame is maintained at the proper height above the axle. When a heavy load is applied to the frame, the drop of the frame is sensed and additional hydraulic fluid is applied to the cylinder to raise the frame to a desired distance from the axle. When that heavy load is removed from the vehicle, the frame rises significantly above the axle. When this occurs, hydraulic fluid is drained from the cylinder to lower the frame with respect to the axle. This type of automatic hydraulic load leveling system ensures that the frame and axle are maintained at the desired separation regardless of the size of the load applied to the vehicle.

The hydraulic cylinder may also function as a shock absorber by regulating the flow of fluid from a chamber on one side of the piston to a chamber on the other side of the piston as the vehicle bounces when traveling over uneven ground. Although this shock absorbing action is beneficial to creating a smoother ride and greater operator comfort, there are times when it is necessary to lock-out an axle to produce a “solid axle”. For example, when the vehicle is carrying a heavy load, there may not be a need for shock absorber action of the suspension as the tires perform that task. Also, the shock absorber action may not be required at relatively low speeds.

### SUMMARY OF THE INVENTION

In one aspect, the invention comprises a hydraulic suspension system for a bed truck, which hydraulic suspension system is configured to accommodate the difference in operation from highway operation to off-road operation, and to facilitate loading and unloading of heavy loads in challenging terrain that varies in elevation between the axles of the bed truck.

In one aspect, the present invention comprises a hydraulic suspension system for use with a bed truck having a frame, a front axle, and at least two rear axles comprising a first rear axle and a second rear axle. The hydraulic suspension system comprises: (a) first and second hydraulic cylinders disposed between the frame and laterally spaced apart portions of the first rear axle, and third and fourth hydraulic cylinders disposed between the frame and laterally spaced apart portions of the second rear axle, wherein each hydraulic cylinder is associated with an accumulator; (b) a hydraulic fluid pressure source, and a fluid tank; (c) a ride height sensor associated with each of the hydraulic cylinders; (d) a high pressure hydraulic circuit connecting each of the hydraulic cylinders and the accumulators to the hydraulic fluid pressure source, and a low pressure hydraulic circuit connecting each of the hydraulic cylinders to the fluid tank; (e) wherein the high pressure hydraulic circuit comprises a plurality of valves operable to isolate operation of any one of the hydraulic cylinders from some or all of the other hydraulic cylinders; and wherein one or more of the plurality of valves are operable to lock any one or more of the hydraulic cylinders at a minimum ride height position; and (f) a control system operably connected to each of the ride height sensors and each of the plurality of valves to control each of the hydraulic cylinders, either independently of all the other hydraulic cylinders, or in concert with one or more the other hydraulic cylinders.

In embodiments of the hydraulic suspension system, the second rear axle is the rearmost axle of the at least one rear axle, and the control system is operable to control the third and fourth hydraulic cylinders to lock the second rear axle at a minimum ride height at the second rear axle. The control system may be operable to allow the first and second hydraulic cylinders to adjust a ride height position at the first axle, while the second rear axle is locked at the minimum ride height position at the second rear axle. The control system may be operable to control the first and second hydraulic cylinders to lock the first rear axle at a minimum ride height position at the first rear axle, independently of locking the second rear axle at the minimum ride height at the second rear axle.

In embodiments of the hydraulic suspension system, the control system is configured to receive a user input for setting a minimum ride height position at either one or both of the first rear axle, and the second rear axle. In embodiments of the hydraulic suspension system, the control system may be configured to receive a user input for setting a minimum ride height position of the first hydraulic cylinder independently of a minimum ride height position of the second hydraulic cylinder.

In embodiments of the hydraulic suspension system, the hydraulic suspension system further comprises the frame, the first rear axle, and the second rear axle.

In another aspect, the present invention comprises a method of controlling a ride height of at one more axles of a bed truck having a frame, a front axle, and at least two rear axles comprising a first rear axle and a second rear axle. The method comprises the steps of:
(a) providing first and second hydraulic cylinders disposed between the frame and laterally spaced apart portions of the first rear axle, and third and fourth hydraulic cylinders disposed between the frame and laterally spaced apart portions of the second rear axle;
(b) setting a minimum ride height position of at least one of the hydraulic cylinder independently of at least one other one of the hydraulic cylinders; and
(c) measuring the ride height of the at least one hydraulic cylinder, and controlling at least one valve to lock the at least one hydraulic cylinder at the minimum ride height position of the least one hydraulic cylinder.

In embodiments of the method, the at least one hydraulic cylinder comprises at least one of the first and second hydraulic cylinders, and the at least one other one of the hydraulic cylinders comprises at least one of the third and fourth hydraulic cylinders. In embodiments of the method, the at least one hydraulic cylinder comprises at least one of the first and third hydraulic cylinders, and the at least one other one of the hydraulic cylinders comprises at least one of the second and fourth hydraulic cylinders.

In embodiments of the method, the second rear axle is the rearmost axle of the at least one rear axle, and setting the minimum ride height position of the at least one hydraulic cylinder comprises setting a minimum ride height position of the third and fourth hydraulic cylinder. Setting the minimum ride height position of the third hydraulic cylinder may be performed independently of setting the minimum ride height position of the fourth hydraulic cylinder. The third and fourth hydraulic cylinders may be locked at their minimum ride height positions while the bed truck is being loaded or unloaded from the rear by an object sliding over a rear edge of the bed truck. The first and second hydraulic cylinders may be allowed to adjust a ride height position at the first rear axle, while the third and fourth hydraulic cylinders are locked at their minimum ride height positions.

### BRIEF DESCRIPTION OF THE DRAWINGS

The invention will now be described by way of an exemplary embodiment with reference to the accompanying simplified, diagrammatic, not-to-scale drawings. Any dimensions provided in the drawings are provided only for illustrative purposes, and do not limit the invention as defined by the claims. In the drawings:

FIG. 1 shows a bed truck with three rear axles and an embodiment of the hydraulic suspension of the present invention;

FIG. 2 is a schematic representation of one embodiment of a hydraulic circuit of the hydraulic suspension of the present invention;

FIG. 3 is a detail view of the portion of FIG. 2, which portion is outlined in dashed line and labelled “A”;

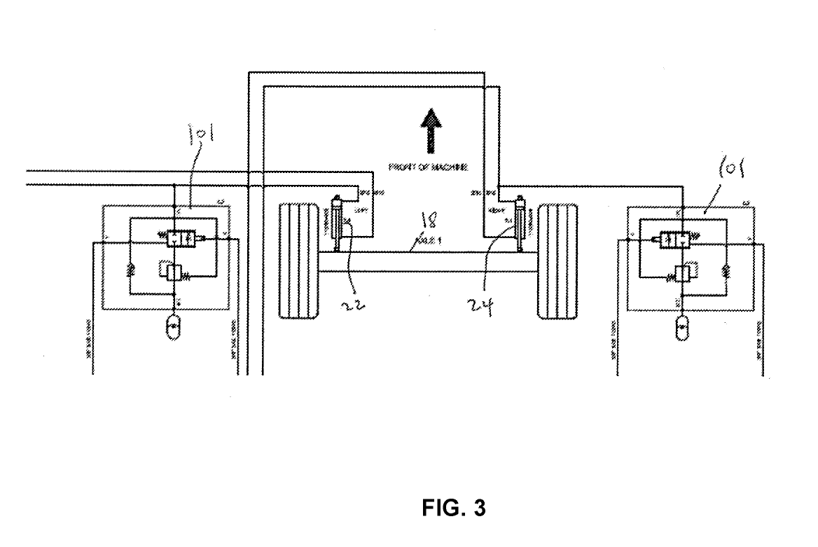

FIG. 4 is a detail view of the portion of FIG. 2, which portion is outlined in dashed line and labelled “B”;

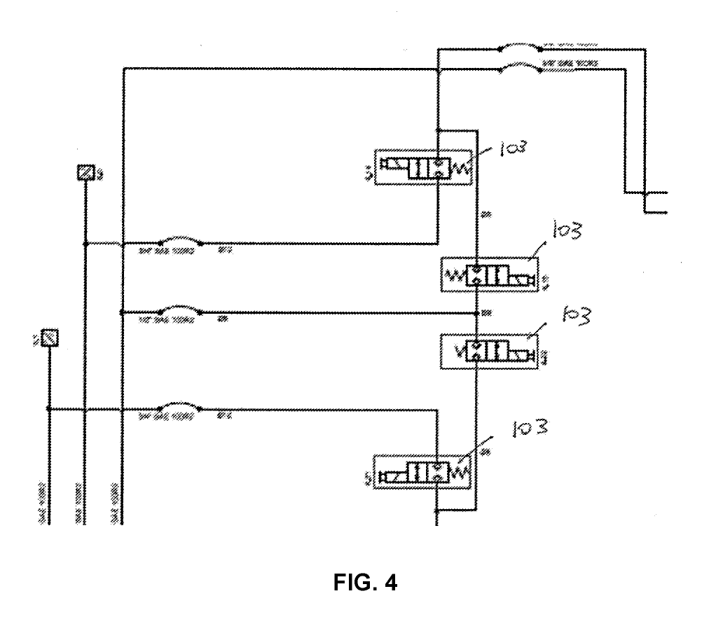

FIG. 5 shows schematically a load being loaded on to the bed truck of FIG. 1 from the rear of the bed truck;

FIG. 6 shows schematically the response of the hydraulic suspension of the bed truck of FIG. 1 to uneven terrain; and

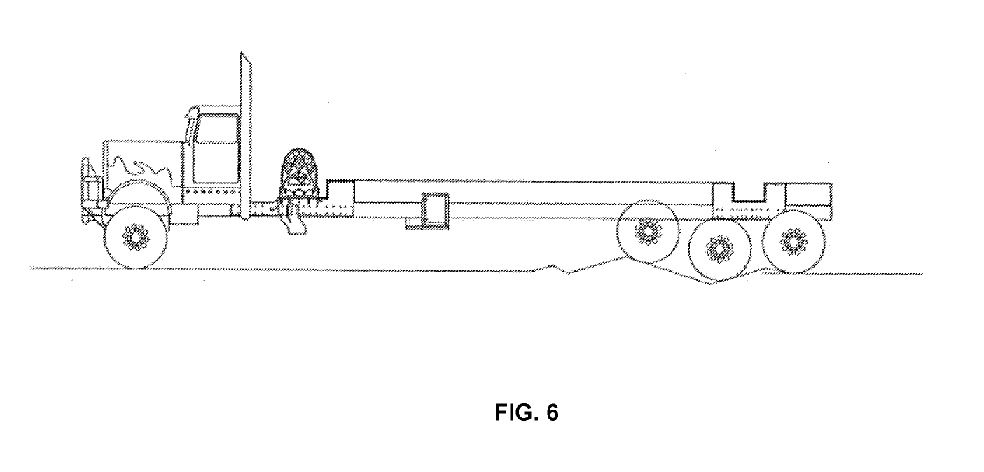

FIG. 7 shows schematically the response of the hydraulic suspension of the bed truck of FIG. 1 to inclined terrain.

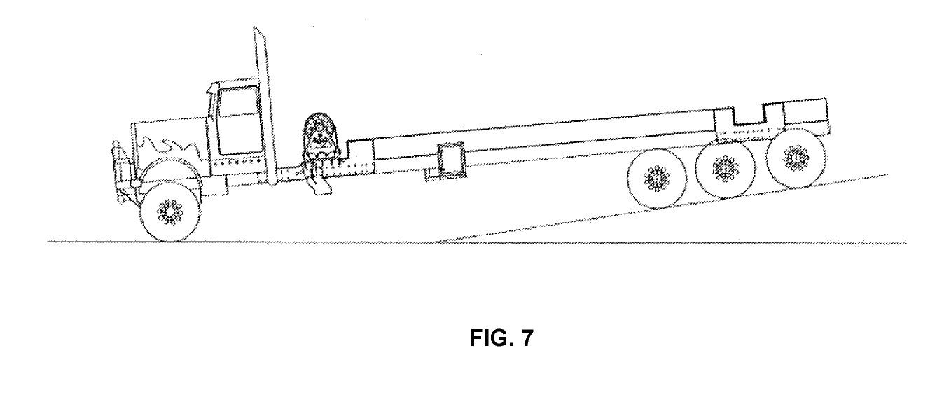

### DETAILED DESCRIPTION OF THE INVENTION

The present invention relates to a hydraulic suspension system for a bed truck.

As used herein, a “bed truck” is a heavy duty commercial vehicle designed to transport heavy loads on a flat bed. Bed trucks have at least one front axle, and typically have two or more rear axles. In non-limiting exemplary uses, bed trucks are used in the oil and gas service industry, or construction industry to load, transport, and unload drilling or service rig substructures, other heavy rig components, or other heavy loads such as bridges.

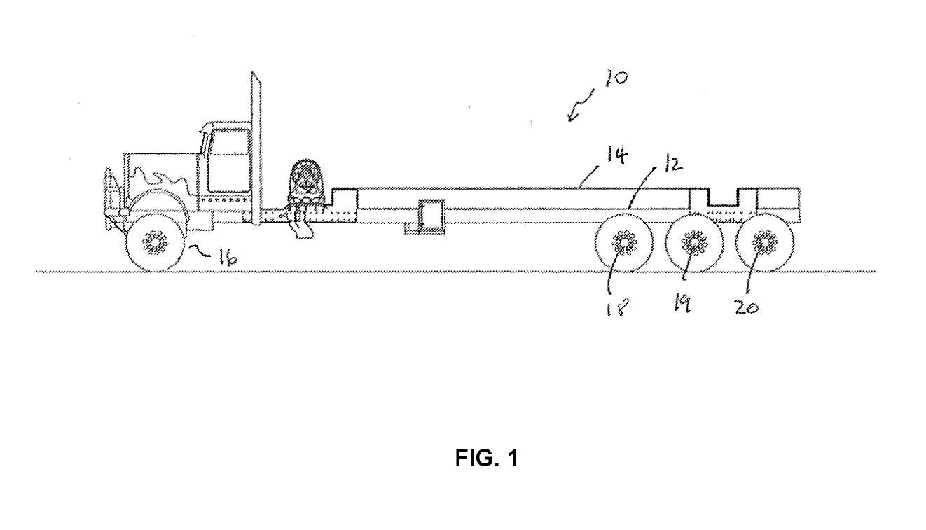

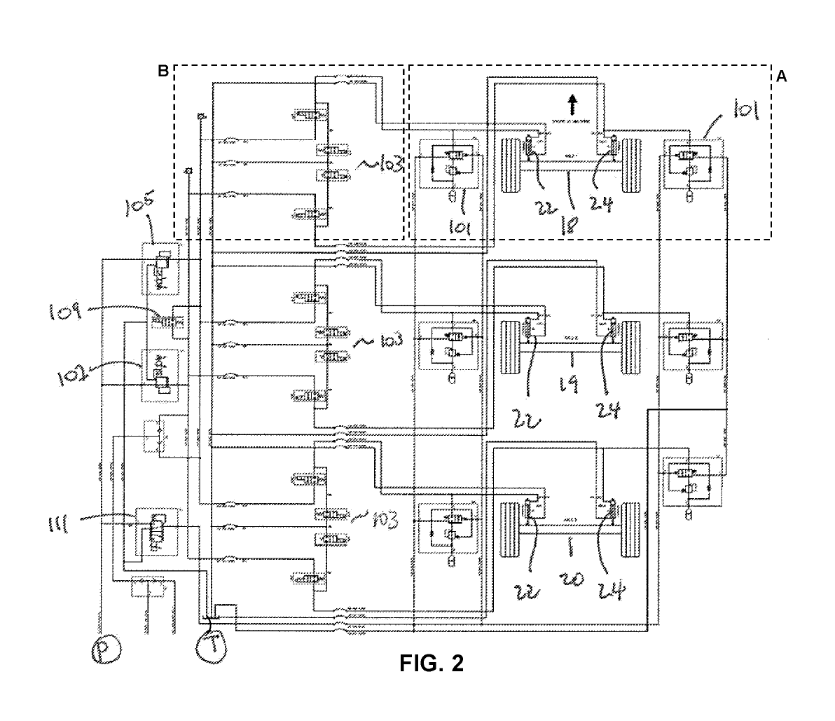

In one aspect, as shown in FIG. 1, the invention comprises a bed truck (10) having a sprung mass comprising a truck frame (12) and a bed (14), and an unsprung mass comprising at least one front axle (16) and three rear axles (18, 19, 20), wherein each rear axle (18, 19 ,20) is separated from the frame (12) by at least a different pair of hydraulic cylinders (22, 24) (as shown in FIG. 2). Each hydraulic cylinder (22, 24) is individually controlled to control the distance between the axle (18, 19, 20) and the frame (12), thereby controlling the ride height of the frame (12) at each hydraulic cylinder (22, 24). Each hydraulic cylinder (22, 24) may be controlled independently, so as to act in concert with some or all of the others, or differently, depending on the circumstances. While the hydraulic cylinders (22, 24) may provide suspension dampening functionality, in one embodiment, at least the rearmost axle (20), and preferably each rear axle (18, 19, 20), can be individually locked so as to maintain a minimum ride height at that axle. As used herein, the expression “locked at a minimum ride height position” and like expressions in describing a hydraulic cylinder (22, 24), means that the pressure that of hydraulic fluid in the hydraulic cylinder is regulated so that the overall length of the hydraulic cylinder between the axle and the frame is maintained above a minimum length so as to maintain the frame (12) above a minimum ride height. The expression “locked at a minimum ride height position” and like expressions include the possibility that the overall length of the hydraulic cylinder between the axle and the frame remains variable above the minimum length. As used herein, the expression “locked at a minimum ride height position” and like expressions in describing a particular rear axle (18, 19, 20) means that the hydraulic cylinders (22, 24) disposed between that particular rear axle (18, 19, 20) and the frame (12) are each locked at a minimum ride height position.

The hydraulic suspension system of the present invention utilizes conventional hydraulic suspension components, and as such, a detailed description of those components is not required to allow one skilled in the art to understand the configuration and operation of the claimed invention. A schematic representation of one embodiment of a hydraulic circuit of the hydraulic suspension is shown in FIG. 2, using symbols and terminology well known to those skilled in the art.

In one embodiment as shown in FIG. 2, the hydraulic suspension system comprises an open hydraulic system with a high pressure circuit including a hydraulic pump pressure source (P) connected to the high pressure side of each hydraulic cylinder (22, 24), and a lower pressure circuit returning hydraulic fluid to a fluid tank (T) from the lower pressure side of each hydraulic cylinder (22, 24).

In one embodiment as shown in FIG. 2, the pressure sides of each hydraulic cylinder (22, 24) are hydraulically connected to a hydraulic pump pressure source (P) with accumulators (101) associated with each hydraulic cylinder (22, 24). Normally closed solenoid valves (103) are provided to allow for selective actuation of either the driver side hydraulic cylinder (22) or passenger side hydraulic cylinder (24) on an individual rear axle (18, 19, 20). A driver side control valve (105) and a passenger side control valve (107), along with a normally closed solenoid valve (109) allows for coordinated actuation of all the hydraulic cylinders (22, 24) along the driver side or passenger side, subject to the position of the normally closed solenoid valves (103) for each rear axle (18, 19, 20).

A suspension dampening valve (111) is connected to the hydraulic pump pressure source (P) both directly to and from the accumulators (101), and to the low pressure side returning to the fluid tank (T).

Each hydraulic cylinder (22, 24) is controlled with a user-actuated control system, which is configured to specify the minimum ride height position of each hydraulic cylinder (22, 24) at each rear axle (18, 19, 20). The control system may comprise a user interface, such as a touch screen input, and a computer processor such as a microprocessor, which is operatively connected to and configured to control the necessary hydraulic valves and pumps, which are shown schematically in FIG. 2.

In one embodiment, rear axle position or ride height feedback is measured through a magnetostrictive position sensor installed within a hydraulic cylinder (22, 24). Ride height manipulation is pressure controlled by means of proportional pressure reducing/relieving valves (103, 105, 107, 109) and accumulators (101) associated with each hydraulic cylinder (22, 24) on each rear axle (18, 19, 20). The microprocessor of the control system may comprise a programmable logic controller which reads in the ride height from the magnetostrictive position sensor and compares it to the desired height, which may be selected by the user. A proportional-integral-derivative (PID) controller is then used to control the valves and pumps (shown in FIG. 2) to manipulate the pressure in the hydraulic cylinder (22, 24) required to achieve the desired ride height of the frame (12) at each rear axle (18, 19, 20).

Ride dampening is provided via nitrogen filled hydraulic accumulators directly tied to the cap end of each hydraulic cylinder (22, 24). The ride dampening is controlled via proportional metering controls that meter fluid in and out of the accumulators.

In one embodiment, hydraulic power is provided by a pressure compensated load sensing piston pump.

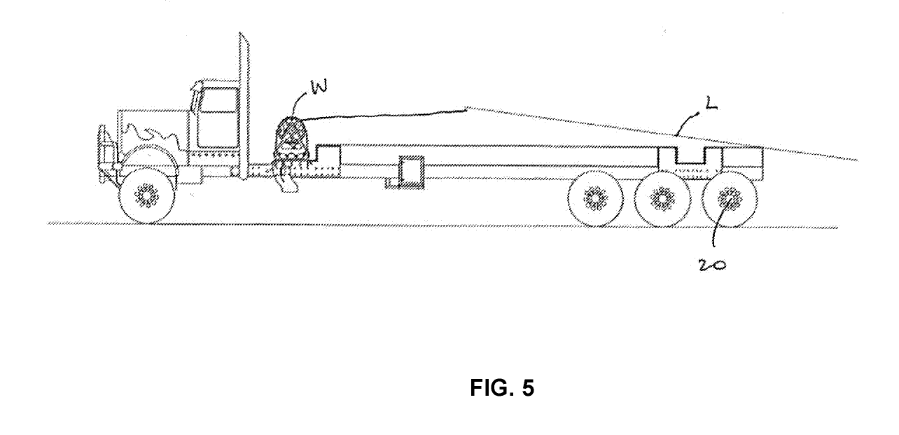

In one embodiment, the bed truck (10) is configured to facilitate self-loading from the rear, whereby a payload (L) is first placed onto the rear of the bed (14) and then slid onto the bed (14) along the longitudinal axis of the bed truck (10), typically by means of a winch (W) mounted at the front end of the bed (14). During the loading process, shown schematically in FIG. 5, the entire weight of the load bears on the rear edge of the bed (14), and thus also bears mostly or entirely on the rearmost axle (20). In one embodiment, the rearmost axle (20) may be locked at a minimum ride height position to maintain the height of the frame (12) at the rearmost axle (20) at a minimum ride height. Thus, the bed truck (10) effectively can support the entire payload on this rearmost axle (20) while loading and unloading. This allows the pivoting point to become the rearmost axle (20) when balancing the rear hanging payload (L) with the weight of the bed truck (10) itself. Accordingly, self-loading and unloading may be accomplished with very high payloads, while maintaining stability of the bed truck and payload (L). In such cases of a bed load, the rearmost axle (20) approaches a balance point supporting all payload (L) and the majority of the bed truck (10) weight. Otherwise, the front end of the bed truck (10) would become unloaded and in extreme cases, the front wheels of the bed truck (10) might rise off the ground, not allowing the bed truck (10) to be steered.

When configured for public highway use, the hydraulic suspension utilizes linked pressure control for each hydraulic cylinder (22, 24) using a suspension dampening valve (111) and the accumulators (101), which are all interconnected, allowing compliance with typical highway safety regulations, such as those imposed by Transport Canada.

Each rear axle (18, 19, 20) may also be locked at a minimum ride height position to maintain a minimum ride height of the frame (12) at each rear axle (18, 19, 20), but still remain pressure compensated at ride heights greater than the minimum ride height. Accordingly, the suspension permits variations in ride height in the normal course, so long as the ride height of the frame (12) exceeds a minimum user-determined value. The tires on a non-point loaded axle may then maintain traction with the ground, and propelling torque even where heavy loads are present on another axle.

The accumulators (101) associated with each hydraulic cylinder (22, 24) may also allow a rear axle (18, 19, 20) which is locked at a minimum ride height position to extend beyond the minimum ride height position if going over a hole or on uneven terrain, but the rear axle (18, 19, 20) will only retract to its locked minimum ride height position. The other non-locked rear axles (18, 19, 20) maintain ride height insuring the propelling traction needed and shared loading on the axles (18, 19, 20).

In one embodiment, the hydraulic circuit may also be configured to vary ride height laterally. Thus, the left side of the rear axle (18, 19, 20) may be set at a different ride height than the right side of the rear axle (18, 19, 20). Thus, the bed truck (10) may load or unload unbalanced payloads and/or on uneven terrain with greater stability.

In another example, a bed truck (10) may be used as a crown transport unit, where a drilling rig mast is transported in one piece to or from an off-road location. A mast may be 100 to 200 feet long and is supported with a derrick dolly on other end. During transport, the dolly or mast may lean, requiring the hydraulic suspension to compensate to match the lean. Otherwise, the connections between the mast and the bed truck (10) may be damaged or shear off entirely. This may be done by automatically or manually changing the set points on the user-actuated control system to set the minimum ride height position of one or more of the rear axles (18, 19, 20).

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The term “communicatively coupled” or “communicatively coupling” includes, but is not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “computer” or “processor” or “control system” describe examples of a suitably configured processing system adapted to implement one or more examples herein. Any suitably configured processing system is similarly able to be used by examples herein, for example and not for limitation, a personal computer, a laptop computer, a tablet computer, a smart phone, a personal digital assistant, a workstation, or the like. A processing system may include one or more processing systems or processors. A processing system can be realized in a centralized fashion in one processing system or in a distributed fashion where different elements are spread across several interconnected processing systems.

The terms “computing system”, “computer system”, and “personal computing system”, describe a processing system that includes a user interface and which is suitably configured and adapted to implement one or more examples of the present disclosure.

The term “portable electronic device” is intended to broadly cover many different types of electronic devices that are portable or that can be transported between locations by a user. For example, and not for any limitation, a portable electronic device can include any one or a combination of the following: a wireless communication device, a laptop personal computer, a notebook computer, a desktop computer, a personal computer, a smart phone, a Personal Digital Assistant, a tablet computer, gaming units, remote controller units, and other handheld electronic devices that can be carried on one's person.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope and spirit of the examples presented or claimed. The disclosed examples were chosen and described in order to best explain the principles of the examples and the practical application, and to enable others of ordinary skill in the art to understand the various examples with various modifications as are suited to the particular use contemplated. It is intended that the appended claims below cover any and all such applications, modifications, and variations within the scope of the examples.

What is claimed is:

1. A hydraulic suspension system for use with a bed truck having a frame, a front axle, and at least two rear axles comprising a first rear axle and a second rear axle, the hydraulic suspension system comprising:
(a) first and second hydraulic cylinders disposed between the frame and laterally spaced apart portions of the first rear axle, and third and fourth hydraulic cylinders disposed between the frame and laterally spaced apart portions of the second rear axle, wherein each hydraulic cylinder is associated with an accumulator;
(b) a hydraulic fluid pressure source, and a fluid tank;
(c) a ride height sensor associated with each of the hydraulic cylinders;
(d) a high pressure hydraulic circuit connecting each of the hydraulic cylinders and the accumulators to the hydraulic fluid pressure source, and a low pressure hydraulic circuit connecting each of the hydraulic cylinders to the fluid tank;
(e) wherein the high pressure hydraulic circuit comprises a plurality of valves operable to isolate operation of any one of the hydraulic cylinders from some or all of the other hydraulic cylinders; and wherein one or more of the plurality of valves are operable to lock any one or more of the hydraulic cylinders at a minimum ride height position; and
)f) a control system operably connected to each of the ride height sensors and each of the plurality of valves to control each of the hydraulic cylinders, either independently of all the other hydraulic cylinders, or in concert with one or more the other hydraulic cylinders.

2. The hydraulic suspension system of claim 1, wherein the second rear axle is the rearmost axle of the at least one rear axle, and wherein the control system is operable to control the third and fourth hydraulic cylinders to lock the second rear axle at a minimum ride height at the second rear axle.

3. The hydraulic suspension system of claim 2, wherein the control system is operable to allow the first and second hydraulic cylinders to adjust a ride height position at the first axle, while the second rear axle is locked at the minimum ride height position at the second rear axle.

4. The hydraulic suspension system of claim 2, wherein the control system is operable to control the first and second hydraulic cylinders to lock the first rear axle at a minimum ride height position at the first rear axle, independently of locking the second rear axle at the minimum ride height at the second rear axle.

5. The hydraulic suspension system of claim 1, wherein the control system is configured to receive a user input for setting a minimum ride height position at either one or both of the first rear axle, and the second rear axle.

6. The hydraulic suspension system of claim 1, wherein the control system is configured to receive a user input for setting a minimum ride height position of the first hydraulic cylinder independently of a minimum ride height position of the second hydraulic cylinder.

7. The hydraulic suspension system of claim 1, further comprising the frame, the first rear axle, and the second rear axle.

8. A method of controlling a ride height of at one more axles of a bed truck having a frame, a front axle, and at least two rear axles comprising a first rear axle and a second rear axle, the method comprising the steps of:
(a) providing first and second hydraulic cylinders disposed between the frame and laterally spaced apart portions of the first rear axle, and third and fourth hydraulic cylinders disposed between the frame and laterally spaced apart portions of the second rear axle;
(b) setting a minimum ride height position of at least one hydraulic cylinder independently of at least one other one of the hydraulic cylinders; and
(c) measuring the ride height of the at least one hydraulic cylinder, and controlling at least one valve to lock the at least one hydraulic cylinder at the minimum ride height position of the least one hydraulic cylinder.

9. The method of claim 8, wherein the at least one hydraulic cylinder comprises at least one of the first and second hydraulic cylinders, and the at least one other one of the hydraulic cylinders comprises at least one of the third and fourth hydraulic cylinders.

10. The method of claim 8, wherein the at least one hydraulic cylinder comprises at least one of the first and third hydraulic cylinders, and the at least one other one of the hydraulic cylinders comprises at least one of the second and fourth hydraulic cylinders.

11. The method of claim 8, wherein the second rear axle is the rearmost axle of the at least one rear axle, and setting the minimum ride height position of the at least one hydraulic cylinder comprises setting a minimum ride height position of the third and fourth hydraulic cylinder.

12. The method of claim 11, wherein setting the minimum ride height position of the third hydraulic cylinder is performed independently of setting the minimum ride height position of the fourth hydraulic cylinder.

13. The method of claim 11, wherein the third and fourth hydraulic cylinders are locked at their minimum ride height positions while the bed truck is being loaded or unloaded from the rear by an object sliding over a rear edge of the bed truck.

14. The method of claim 13, wherein the first and second hydraulic cylinders are allowed to adjust a ride height position at the first rear axle, while the third and fourth hydraulic cylinders are locked at their minimum ride height positions.
